(19) United States
(12) Patent Application Publication
(10) Pub. No.: US 2020/0047469 A1
(43) Pub. Date: Feb. 13, 2020

(54) WEATHER-RESISTANT COMPOSITE FLOOR AND PREPARATION METHOD THEREOF, AND ARTIFICIAL MINERAL BOARD AND PREPARATION METHOD THEREOF

(71) Applicant: ZHEJIANG TIANZHEN BAMBOO & WOOD DEVELOPMENT CO., LTD, Huzhou City (CN)

(72) Inventor: Qinghua FANG, Huzhou City (CN)

(73) Assignee: ZHEJIANG TIANZHEN BAMBOO & WOOD DEVELOPMENT CO., LTD, Huzhou City (CN)

(21) Appl. No.: 16/245,688

(22) Filed: Jan. 11, 2019

(30) Foreign Application Priority Data
Aug. 13, 2018 (CN) 201810915004.0

(51) Int. Cl. B32B 21/02; B32B 27/08; B32B 7/12; B32B 21/04; B32B 21/08; E04C 2/296

(52) U.S. Cl. CPC B32B 21/02; B32B 27/08; B32B 7/12; B32B 21/042; B32B 2272/00; E04C 2/296; B32B 2307/712; B32B 2419/00; B32B 21/08

(57) ABSTRACT

The present invention belongs to the technical field of board materials, and particularly relates to a weather-resistant composite floor and a preparation method thereof, and an artificial mineral floor and a preparation method thereof. The weather-resistant composite floor provided by the present invention sequentially includes a wear layer, an artificial mineral board and a back lay which are laminated and bonded with one another; the artificial mineral board includes modified mineral layers and fiberglass mesh layers which are alternately laminated; and the bottom and top layers of the artificial mineral board are the modified mineral layers. The wear layer and the back lay are respectively bonded to two opposite sides of the artificial mineral board. The weather-resistant composite floor provided by the present invention has high dimensional stability, and the deformation amount of it is maintained at a relatively small amplitude even in the presence of moisture or under an alternate cooling and heating condition, and thus is applicable in a wide range of areas.

This application claims priority to Chinese patent application number 201810915004.0, filed on Aug. 13, 2018, entitled “ARTIFICIAL MINERAL BOARD AND PREPARATION METHOD THEREOF, AND COMPOSITE FLOOR AND PREPARATION METHOD THEREOF”, which is incorporated herein by reference in its entirety.

### TECHNICAL FIELD

The present invention belongs to the technical field of board materials, and particularly relates to a weather-resistant composite floor and a preparation method thereof, and an artificial mineral board and a preparation method thereof.

### BACKGROUND

With the continuous development of society, people have increasingly higher requirements on home improvement materials. A natural stone material, when used as a floor material, causes inconvenience to processing and flooring due to the heavy weight of the stone material itself, and is gradually replaced by a wooden floor. The wooden floor is lightweight, and is more convenient for transporting, processing and flooring. However, due to the large differences in temperatures and moistures of different areas, the existing wooden floor is easily deformed under a humid environment or an environment having alternating high and low temperatures, which affects the aesthetics and practicality of the wooden floor.

### SUMMARY

An objective of the present invention is to provide a weather-resistant composite floor and a preparation method thereof. The composite floor provided by the present invention has excellent dimensional stability such that the dimensional stability can still be maintained in a relatively lower range even in existence of alternating high and low temperatures or moistures.

To achieve the above objective, the present invention provides the following technical solutions:

A weather-resistant composite floor, sequentially including a wear layer, an artificial mineral board and a back lay which are laminated and bonded with one another;

where the artificial mineral board includes modified mineral layers and fiberglass mesh layers which are alternately laminated; and the bottom and top layers of the artificial mineral board are the modified mineral layers.

Preferably, the raw material forming the modified mineral layers includes the following components by mass: 60-80 parts of a mineral base material, 20-24 parts of wood chips, 3-5 parts of a modifier, and 20-25 parts of water; and the mineral base material includes magnesium oxide and magnesium chloride.

Preferably, the modifier includes sodium methine dinaphthyl sulphonate, ferrous sulfate, oxalic acid, trisodium phosphate, sodium methyl nitrate, dibutyl phthalate, phenol, xylene, toluene, ethylenediamine, sulfuric acid, sodium hexametaphosphate, sodium nitrite, methylcellulose, formaldehyde, casein, gelatin, sodium pentachlorophenolate, sodium fluorosilicate, water glass, and water.

Preferably, the wood chips include straw chips.

Preferably, the weather-resistant composite floor has a thickness of 2-12 mm.

Preferably, two opposite side end portions of the weather-resistant composite floor are respectively provided with a flange and a groove which can be snap-fitted with the flange.

The present invention further provides a method for preparing the above-mentioned weather-resistant composite floor, including the steps of:

(a) pasting a wear-resistant paper onto a top layer of an artificial mineral board, pasting a balance paper onto a bottom layer of the artificial mineral board, and hot pressing to obtain a semi-finished product of the weather-resistant composite floor; and

(b) pasting a back lay onto a face of the balance paper of the semi-finished product of the weather-resistant composite floor obtained in step (a), and then cold pressing to obtain the weather-resistant composite floor.

Preferably, in step (a) the heat-pressing temperature is 100-190° C.; the heat-pressing pressure is 2-15 MPa; and the heat-pressing time is 0.5-30 min.

The present invention further provides the above-mentioned weather-resistant composite floor, or an artificial mineral board in the weather-resistant composite floor prepared by the above-mentioned preparation method, where the artificial mineral board includes the modified mineral layers and the fiberglass mesh layers which are alternately laminated; the bottom and top layers of the artificial mineral board are the modified mineral layers; and the thickness of the artificial mineral board is 1-10 mm.

The present invention further provides a method for preparing the above-mentioned artificial mineral board, including the steps of:

(1) mixing raw materials of the modified mineral layer to undergo a modification reaction, so as to obtain a modified mineral slurry;

(2) alternately laying the modified mineral slurry obtained in step (1) and the fiberglass mesh into a mold, and then sequentially curing and demolding to obtain a primary blank of the artificial mineral board containing the modified mineral layers and the fiberglass mesh layers; where the bottom and top layers of the primary blank of the artificial mineral board are the modified mineral layers; and

(3) sequentially performing curing and sanding on the primary blank of the artificial mineral board obtained in step (2) to obtain the artificial mineral board.

The weather-resistant composite floor provided by the present invention sequentially includes a wear layer, an artificial mineral board and a back lay which are laminated and bonded with one another. The artificial mineral board includes modified mineral layers and fiberglass mesh layers which are alternately laminated; and the bottom and top layers of the artificial mineral board are the modified mineral layers. In the present invention, the wear layer and the back lay are pasted on two opposite sides of the artificial mineral board respectively, so as to improve the wear resistance of the surface of the composite floor and improve the cushioning performance of the composite floor; and the artificial mineral board can enable water penetration and prevent deformation of board materials caused by water retained inside the composite floor. The results of the embodiments show that, when the weather-resistant composite floor provided by the present invention is stood at 80° C. for 6 h and then cooled for 6 h, before and after heating the weather-resistant composite floor has a length contracted by 0.02-0.10%, and a warping degree of 0.225-0.413 mm; and after soaked in water for 24 hours, the weather-resistant composite floor is expanded by 0.02-0.05%, has a thickness expanded by 1.33-1.57%, and a warping degree of 0.2625-0.425 mm.

### BRIEF DESCRIPTION OF THE DRAWINGS

FIG. 1 is a schematic structural view of a weather-resistant composite floor obtained in Embodiment 1;

FIG. 2 is a schematic structural view of an artificial mineral board obtained in Embodiment 1;

FIGS. 3 and 4 show schematic structural views of a snap-fit structure of the weather-resistant composite floor obtained in Embodiment 1; and

FIG. 5 is a smoke density diagram of the weather-resistant composite floor obtained in Embodiment 1.

### DETAILED DESCRIPTION

The present invention provides a weather-resistant composite floor, which, as shown in FIG. 1, sequentially includes a wear layer B, an artificial mineral board A and a back lay C which are laminated and bonded with one another. The artificial mineral board includes modified mineral layers and fiberglass mesh layers which are alternately laminated; and the bottom and top layers of the artificial mineral board are the modified mineral layers.

The weather-resistant composite floor provided by the present invention includes the artificial mineral board. In the present invention, the artificial mineral board preferably includes the modified mineral layers and the fiberglass mesh layers which are alternately laminated; and the bottom and top layers of the artificial mineral board are the modified mineral layers.

In the present invention, the raw material forming the modified mineral layers preferably includes the following components by mass: 60-80 parts of a mineral base material, 20-24 parts of wood chips, 3-5 parts of a modifier, and 20-25 parts of water; and the mineral base material preferably includes magnesium oxide and magnesium chloride.

The raw material of the modified mineral layer of the present invention preferably includes 60-80 parts, more preferably 65-78 parts, and even more preferably 68-75 parts of the mineral base material. In the present invention, the mineral base material preferably includes magnesium oxide and magnesium chloride; and the mass ratio of magnesium oxide to magnesium chloride is preferably (30-40):(15-25), and more preferably (32-37):(18-23). The present invention has no special requirement on the source of magnesium oxide and magnesium chloride, and a commercially available product well known to those skilled in the art can be adopted.

The raw material of the modified mineral layer of the present invention includes 20-24 parts, particularly 20 parts, 21 parts, 22 parts, 23 parts and 24 parts of the wood chips, based on the mass part of the mineral base material. In the present invention, the wood chips preferably include straw chips. The present invention has no special requirement on the particle size of the wood chips, and a particle size well known to those skilled in the art can be adopted. The present invention utilizes the wood chips as the raw materials, and thus uses flexible plant fibers contained in the wood chips to improve the toughness of the artificial mineral board and reduce the density of the artificial mineral board; and additionally, using the wood chips as the raw materials for preparing the artificial mineral board can improve the utilization rate of the wood chips and reduce environmental pollution caused by burning the wood chips.

The raw material of the modified mineral layer of the present invention includes 3-5 parts, and preferably 3.5-4.5 parts of the modifier, based on the mass part of the mineral base material. In the present invention, the modifier preferably includes sodium methine dinaphthyl sulphonate, ferrous sulfate, oxalic acid, trisodium phosphate, sodium methyl nitrate, dibutyl phthalate, phenol, xylene, toluene, ethylenediamine, sulfuric acid, sodium hexametaphosphate, sodium nitrite, methylcellulose, formaldehyde, casein, gelatin, sodium pentachlorophenolate, sodium fluorosilicate, water glass, and water.

In the present invention, the modifier preferably includes by mass percent: 2-2.5% of sodium methine dinaphthyl sulphonate, 9-12% of ferrous sulfate, 12-15% of oxalic acid, 0.5-0.8% of trisodium phosphate, 0.5-1.0% of sodium methyl nitrate, 0.3-0.5% of dibutyl phthalate, 0.7-1.0% of phenol, 0.6-1.0% of xylene, 0.6-1.0% of toluene, 0.5-0.7% of ethylenediamine, 5-8% of sulfuric acid, 1.0-1.2% of sodium hexametaphosphate, 0.5-0.7% of sodium nitrite, 1.8-2.5% of methylcellulose, 0.8-1.5% of formaldehyde, 0.8-1.5% of casein, 7-8% of gelatin, 0.01-0.05% of sodium pentachlorophenolate, 0.01-0.5% of sodium fluorosilicate, 0.5-1.0% of water glass, and the balance water, and more preferably 2% of sodium methine dinaphthyl sulphonate, 10% of ferrous sulfate, 13% of oxalic acid, 0.6% of trisodium phosphate, 0.8% of sodium methyl nitrate, 0.4% of dibutyl phthalate, 0.8% of phenol, 0.8% of xylene, 0.8% of toluene, 0.5% of ethylenediamine, 7% of sulfuric acid, 1.08% of sodium hexametaphosphate, 0.5% of sodium nitrite, 2% of methylcellulose, 1% of formaldehyde, 1% of casein, 8% of gelatin, 0.02% of sodium pentachlorophenolate, 0.2% of sodium fluorosilicate, 0.6% of water glass, and the balance water.

In the present invention, sodium methine dinaphthyl sulphonate can improve the dispersing performance of each component, and thus provide a basis for obtaining an artificial mineral board having uniform performances; oxalic acid can inhibit the expansion performance of the modified mineral layer under the action of trisodium phosphate; methyl sodium nitrate can be hydrolyzed to generate methyl silicon, which acts simultaneously with sodium fluosilicate and water glass to improve the waterproof performance of the artificial mineral board; sodium hexametaphosphate, methyl cellulose can improve the bonding force between the mineral base materials; and casein can react with formaldehyde to form a case in plastic, thereby further improving the water resistance performance of the artificial mineral board. The present invention has no special requirement on sources of respective components of the modifier, and commercially available products well known to those skilled in the art can be adopted.

The raw material of the modified mineral layer of the present invention includes 20-25 parts, and preferably 21-24 parts of water, based on the mass part of the mineral base material.

In the present invention, the mineral base material, the wood chips, the modifier and water act cooperatively to form a modified mineral layer having stable strength and dimensional performances. In the present invention, the modified mineral layers and the fiberglass mesh layers are alternately laminated in the artificial mineral board; and in the artificial mineral board, the number of layers of the modified mineral layers is preferably ≤2, and further preferably 2-5.

The artificial mineral board of the present invention also includes the fiberglass mesh layers. The present invention has no special requirement on the number of layers of the fiberglass mesh layers, as long as the number of layers of the fiberglass mesh layers matches the number of layers of the modified mineral layers, and the bottom and top layers of the artificial mineral board are the modified mineral layers.

In the present invention, the fiberglass mesh is laid as a single layer. In the present invention, the chemical composition of the fiberglass mesh preferably includes a metal oxide which has a mass content of preferably 11-17%, and further preferably 11.9-16.4%; the fiberglass mesh has grid meshes with a size preferably of 5 mm×5 mm or 4 mm×4 mm; the density of the fiberglass mesh is preferably 80-165 g/m², and further preferably 100-140 g/m²; and the tensile strength of a monofilament in the fiberglass mesh is preferably 1.57-3.43 GPa; and further preferably 2-3 GPa. The present invention preferably uses the aforementioned fiberglass mesh as a reinforcing material of the artificial mineral board, and uses fibers as a skeleton to improve the load capacity of the artificial mineral board.

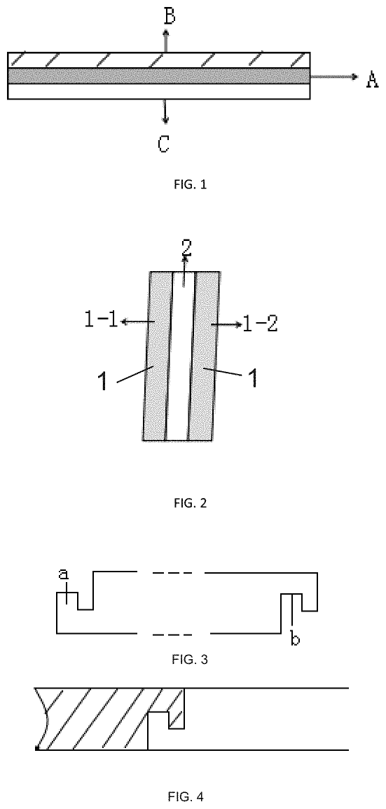

As shown in FIG. 2, the artificial mineral board of the present invention includes modified mineral layers 1 and fiberglass mesh layers 2; the modified mineral layers 1 and the fiberglass mesh layers 2 are alternately laminated; and the bottom and top layers of the artificial mineral board are a modified mineral layer 1-1 and a modified mineral layer 1-2, respectively.

In the present invention, the thickness of the artificial mineral board is preferably about 1-10 mm, and more preferably about 3-7 mm. The present invention has no special requirement on the length and width of the artificial mineral board. The artificial mineral board for testing dimensional stability has a lateral length preferably of about 3,350-3,360 mm, and a longitudinal length preferably of about 2,400-2,410 mm.

The present invention preferably uses a changing rate as a measuring standard of the dimensional stability of the artificial mineral board. In the present invention, the changing rate is calculated as: changing rate (%)=(a dimension parameter of a sample before test—a dimension parameter of the sample after test)/the dimension parameter of the sample before test. When the changing rate is positive, it represents that under this condition, shrinkage occurs in the dimension of the test sample. When the changing rate is negative, it represents that under this condition, expansion occurs in the dimension of the test sample. In the present invention, the dimension parameter preferably includes a length, a thickness, and a warping degree; and the length includes a longitudinal length and a lateral length.

The artificial mineral board of the present invention has excellent high-temperature resistance and waterproof performances. In the present invention, the artificial mineral board is placed at conditions of 0° C., 25° C. and 40° C. each for 24 h and measured, and then the length changing rates of the artificial mineral board are calculated to characterize the thermal expansion performance of the artificial mineral board under an alternate cooling and heating condition. Under the condition of 0-25° C., the length changing rate of the artificial mineral board is −0.04% to −0.05%; under the condition of 25-40° C., the length changing rate of the artificial mineral board is −0.02% to −0.03%; and under the condition of 0-40° C., the length changing rate of the artificial mineral board is −0.06 to −0.08%.

In the present invention, standing at 80° C. for 6 h is used as a heating test condition to characterize the dimensional stability of the artificial mineral board. In the present invention, the length changing rate of the artificial mineral board after being heated is 0.04-0.09%, and the warping degree of the artificial mineral board after being heated is 0.045-0.083 mm.

In the present invention, soaking in water for 24 h is used as a condition for testing a waterproof performance, so as to characterize the waterproof performance of the artificial mineral board. In the present invention, the length changing rate of the artificial mineral board after the waterproof test is an expansion of 0.03-0.06%; the thickness changing rate of the artificial mineral board is an expansion of 0.86-1.92%; and the warping degree of the artificial mineral board is 0.65-1.075 mm.

The weather-resistant composite floor provided by the present invention further includes a wear layer and a back lay which are laminated and bonded on the top layer and the bottom layer of the artificial mineral board.

In the present invention, the components of the wear layer preferably include an aluminum oxide resin and a melamine resin. The present invention has no special requirement on the mass ratio of the aluminum oxide resin to the melamine resin, and a ratio well known to those skilled in the art can be used. In the present invention, the wear layer is preferably pasted onto one face of the artificial mineral board via an adhesive; and the adhesive preferably includes a polyurethane adhesive and/or a melamine formaldehyde resin adhesive; and more preferably a melamine formaldehyde resin adhesive. When the resin adhesive is a mixture of two components, the present invention has no special requirement on the dosage ratio of respective components in the mixture. The present invention has no special requirement on sources of the polyurethane adhesive and the melamine formaldehyde resin adhesive, and a commercially available product well known to those skilled in the art can be used. The present invention has no special requirement on the dosage of the adhesive, as long as the wear layer can be pasted onto the artificial mineral board.

The present invention has no special requirement on the chemical composition of the back lay, and a chemical composition well known to those skilled in the art can be used. In the present invention, the adhesive between the back lay and the artificial mineral board preferably has a same selection range as that of the adhesive for pasting the wear layer described in the above technical solution, and will not be repeated any more herein. The present invention has no special requirement on the dosage of the adhesive, as long as the back lay can be pasted onto the artificial mineral board.

In the present invention, the wear layer and the back lay are laminated and bonded to the top layer and the bottom layer of the artificial mineral board, such that the wear layer is used to improve the wear resistance of the weather-resistant composite floor and the back lay is used to absorb and reduce noise, thereby enhancing foot feeling and degree of comfort.

In the present invention, the thickness ratio of the wear layer, the artificial mineral board and the back lay is 1:(9-15):(2-5), and further preferably 1:(10-12):(3-4). In the present invention, the total thickness of the weather-resistant composite floor is preferably 2-12 mm, and further preferably 5-10 mm. In the present invention, the total thickness of the weather-resistant composite floor is preferably controlled within the above range, such that the dosage of the raw material can be reduced on a basis not affecting the comprehensive performance of the weather-resistant composite floor, and thus the weight of the weather-resistant composite floor is decreased, which is convenient for transportation and installation.

As a preferred embodiment of the present invention, in order to further improve the convenience for the installation of the composite floor, the present invention additionally provides a weather-resistant composite floor as shown in FIGS. 3 and 4. In FIG. 3, two opposite side end portions of the weather-resistant composite floor are respectively provided with a flange “a” and a groove “b” which can be snap-fitted with the flange “a”. That is, the flange “a” is disposed on one side of the weather-resistant composite floor, and the groove “b” snap-fitted with the flange “a” is disposed on the opposite side of the weather-resistant composite floor; and when the floor is spread, the flange “a” of the weather-resistant composite floor can be snap-fitted into the groove “b” of an adjacent weather-resistant composite floor, to form a locking structure as shown in FIG. 4. The present invention has no special requirement on the dimensions of the flange a and the groove b, and dimensions well known to those skilled in the art can be used. In the embodiments of the present invention, the height of the flange a is consistent with the depth of the groove b, and the height of the flange a preferably accounts for ⅕- 1/7 of the thickness of the weather-resistant composite floor.

The weather-resistant composite floor of the present invention has excellent dimensional stability, strength performances, wear-resistant performances and flame retardant performance.

The method for measuring the performance of the weather-resistant composite floor of the present invention is consistent with that of the artificial mineral board described in the above technical solution, and will not be repeated any more herein. In the present invention, standing at 80° C. for 6 h and then cooling naturally for 6 h is used as a heating test condition to characterize the dimensional stability of the weather-resistant composite floor. In the present invention, the weather-resistant composite floor has a length contracted by 0.02-0.10% after being heated, and the weather-resistant composite floor has a warping degree of 0.225-0.413 mm after being heated.

In the present invention, soaking in water for 24 hours is used as a condition for testing a waterproof performance, so as to characterize the waterproof performance of the weather-resistant composite floor. In the present invention, after the waterproof test, the length of the weather-resistant composite floor is expanded by 0.02 to 0.05%; the thickness of the weather-resistant composite floor is expanded by 1.33-1.57%; and the warping degree of the weather-resistant composite floor is 0.2625-0.425 mm.

In the present invention, the static bending strength of the weather-resistant composite floor is tested according to an American Society for Testing and Materials ASTM D1037 standard, and the static bending strength of the weather-resistant composite floor is preferably 16.6-17.1 MPa.

In the present invention, the wear-resistant performance of the weather-resistant composite floor is tested according to a NALFA 3.7 standard, and the wear-resisting revolution of the weather-resistant composite floor is preferably 4,800-5,000 turns.

In the present invention, the residual indentation of the weather-resistant composite floor is tested according to an ASTM F1914 standard, so as to characterize the recovery capability of the weather-resistant composite flooring after subjected to a force. In the present invention, the residual indentation of the weather-resistant composite floor is preferably 0-0.03 mm.

In the present invention, the static load of the weather-resistant composite floor is tested according to an ASTM F970 standard, so as to characterize the static-load resistance capability of the weather-resistant composite floor. In the present invention, the static load of the weather-resistant composite floor is preferably 0.02-0.04 mm.

In the present invention, the flame retardant performance of the weather-resistant composite floor is tested by using a plastic smoke density tester, in accordance with an ASTM E662 testing standard. The weather-resistant composite floor has a smoke density

The present invention also provides a method for preparing the weather-resistant composite floor described in the above technical solution, which includes the steps of:

(a) pasting a wear-resistant paper onto a top layer of an artificial mineral board, pasting a balance paper onto a bottom layer of the artificial mineral board, and hot pressing to obtain a semi-finished product of the weather-resistant composite floor; and

(b) pasting a back lay onto a face of the balance paper of the semi-finished product of the weather-resistant composite floor obtained in step (a), and then cold pressing to obtain the weather-resistant composite floor.

In the present invention, the wear-resistant paper is pasted onto the top layer of the artificial mineral board, the balance paper is pasted onto the bottom layer of the artificial mineral board, and they are hot pressed to obtain the semi-finished product of the weather-resistant composite floor. The present invention has no special requirement on the source of the wear-resistant paper, and the wear-resistant paper can be a commercially available product well known to those skilled in the art, or can be homemade. In an embodiment of the present invention, the wear-resistant paper is preferably a commercially available product.

In the present invention, when the wear-resistant paper is homemade, the method for preparing the wear-resistant paper preferably includes: immersing a decorative paper with a mixture containing an adhesive and a wear-resistant material to obtain the wear-resistant paper. In the present invention, the adhesive preferably includes a melamine resin; the wear-resistant material preferably includes aluminum oxide; and the aluminum oxide is preferably aluminum oxide powder. In the present invention, the particle diameter of the aluminum oxide powder is preferably 30-40 μm, and further preferably 32-36 μm. The present invention has no special requirement on the mass ratio of the adhesive to the wear-resistant material, and a mass ratio well known to those skilled in the art can be used. The present invention has no particular requirement on the particular forming manner of the mixture, and a manner well known to those skilled in the art can be used.

The present invention has no special requirement on the source of the decorative paper, and a commercially available product well known to those skilled in the art can be used. The present invention has no special requirement on the implementation of the immersion, and an immersion manner well known to those skilled in the art can be used.

In the present invention, the wear-resistant paper and the balance paper are preferably pasted onto the top layer and the bottom layer of the artificial mineral board via an adhesive respectively, where the wear-resistant paper forms the wear-resistant layer, and one side of the balance paper is used for pasting the back lay. The present invention has no special requirement on the particular source of the balance paper, and a commercially available product well known to those skilled in the art can be used.

In the present invention, the chemical composition of the adhesive is consistent with that of the adhesive described in the above-mentioned technical solution for preparing the wear-resistant paper, and will not be repeated any more herein. The present invention has no special requirement on the dosage of the adhesive, and a dosage well known to those skilled in the art can be used. The present invention has no special requirement on the implementation of the pasting, and a pasting manner well known to those skilled in the art can be used.

in the present invention, after pasting, the artificial mineral board, which has the wear-resistant paper and the balance paper respectively pasted on the top layer and the bottom layer thereof, is subjected to hot pressing to obtain the semi-finished product of the weather-resistant composite floor. In the present invention, the hot-pressing temperature is preferably 100-190° C., further preferably 140-180° C., and more preferably 150-175° C.; the hot-pressing pressure is preferably 2-15 MPa, further preferably 3-13 MPa, and more preferably 4-11 MPa; and the hot-pressing time is preferably 0.5-30 min, further preferably 0.5-25 min, and more preferably 0.5-22 min. In the present invention, the hot pressing is preferably performed under the above conditions for enabling curing of the melamine resin within the wear-resistant paper to obtain a wear-resistant layer with better wear resistance.

In the present invention, after the semi-finished product of the weather-resistant composite floor is obtained, the back lay is pasted onto a side of the balance paper of the semi-finished product of the weather-resistant composite floor and then cold pressing is conducted to obtain the weather-resistant composite floor. The back lay of the present invention is identical to the back lay described in the above technical solution, and will not be repeated any more herein. In the present invention, the cold-pressing temperature is preferably 15-30° C., and further preferably 20-25° C.; the cold-pressing pressure is preferably 10-15 MPa, and further preferably 12-14 MPa; and the cold-pressing time is preferably 60-120 min, and further preferably 70-110 min. In the present invention, the cold pressing is preferably performed under the above conditions to improve the durability of the pasting between the back lay and the artificial mineral board.

In the present invention, after the cold pressing, post-processing is preferably conducted on the cold-pressed board material to obtain the weather-resistant composite floor, thereby improving the flooring efficiency of the weather-resistant composite floor. In the present invention, the post-processing refers to establishing a flange and a groove that can be snap-fitted with the flange on two opposite sides of the board material after the cold pressing. The present invention has no special requirement on the manner in which the flange and the groove are established, as long as the control of the above dimensions can be achieved.

In the present invention, the performance of the weather-resistant composite floor prepared by the preparation method described in the aforementioned technical solution is consistent with that of the weather-resistant composite floor described in the aforementioned technical solution, and will not be repeated any more herein.

The present invention has no special requirement on the flooring method of the weather-resistant composite floor, and a flooring method well known to those skilled in the art can be used.

The present invention also provides the weather-resistant composite floor described in the aforementioned technical solution, or the artificial mineral board in the weather-resistant composite floor prepared by the preparation method described in the aforementioned technical solution. The artificial mineral board includes the modified mineral layers and the fiberglass mesh layers which are alternately laminated; and the bottom and top layers of the artificial mineral board are the modified mineral layers.

The composition and structure of the artificial mineral board of the present invention are consistent with those of the artificial mineral board described in the aforementioned weather-resistant composite floor, and will not be repeated any more herein.

The present invention also provides a method for preparing the artificial mineral board described in the aforementioned technical solution, which includes the steps of:

(1) mixing raw materials of the modified mineral layer to undergo a modification reaction, so as to obtain a modified mineral slurry;

(2) alternately laying the modified mineral slurry obtained in step (1) and the fiberglass mesh into a mold, and then sequentially curing and demolding to obtain a primary blank of the artificial mineral board containing the modified mineral layers and the fiberglass mesh layers; where the bottom and top layers of the primary blank of the artificial mineral board are the modified mineral layers; and

(3) sequentially performing curing and sanding on the primary blank of the artificial mineral board obtained in step (2) to obtain the artificial mineral board.

In the present invention, it is preferred to mix the raw materials of the modified mineral layer to undergo a modification reaction, so as to obtain the modified mineral slurry. In the present invention, in the raw materials of the modified mineral layer magnesium oxide, magnesium chloride and water react under the action of the modifier to generate a ternary system of a magnesian gel material, so as to obtain the modified mineral slurry. In the present invention, the chemical composition and dosage of the raw materials of the modified mineral layer are consistent with those of the materials in the modified mineral layer described in the aforementioned weather-resistant floor, and are not repeated any more herein.

In the present invention, after the modified mineral slurry is obtained, the modified mineral slurry and the fiberglass mesh are preferably layered alternately, and then sequentially subjected to curing and demolding, to obtain the primary blank of the artificial mineral board containing the modified mineral layers and the fiberglass mesh layers. In the present invention, the alternate layering of the modified mineral slurry and the fiberglass mesh is conducted in a mold. The present invention has no special requirement on the particular dimension of the mold, and a mold well known to those skilled in the art can be used.

In the present invention, the implementation of the alternate layering is preferably layering the modified mineral slurry, and then layering one layer of fiberglass mesh on the surface layer of the modified mineral slurry; and after the layering of the fiberglass mesh, further layering the modified mineral slurry onto the surface layer of the fiberglass mesh. The present invention has no special requirement on the layering numbers of the modified mineral slurry and the fiberglass mesh, as long as a primary blank having a structural composition consistent with that of the artificial mineral board described in the aforementioned technical solution can be formed.

The present invention has no special requirement on the layering thickness of the modified mineral slurry, and the layering thickness can be set according to actual needs. In the embodiments of the present invention, the layering thickness of the modified mineral slurry is preferably 1.5-4 mm, and further preferably 2-3 mm. The present invention has no special requirement on the layering manner of the modified mineral slurry, and a layering method well known to those skilled in the art can be used.

In the present invention, when the layering number of layers of the modified mineral slurry is multiple, the layering thicknesses of the different layers of the modified mineral slurry may be the same or different.

The present invention has no special requirement on the layering manner of the fiberglass mesh, as long as the fiberglass mesh can be laid flat on the upper surface of the modified mineral slurry.

The layering number of layers of the modified mineral slurry and the layering number of layers of the fiberglass mesh in the present invention are consistent with the number of the modified mineral layers and the number of the fiberglass mesh layers described in the aforementioned technical solution, and will not be repeated any more herein.

In the present invention, after the alternate layering, sequential curing and demolding are preferably performed on the slurry alternately layered in the mold, to obtain the primary blank of the artificial mineral board containing the modified mineral layers and the fiberglass mesh layers. In the present invention, the curing manner is preferably standing, and the standing time is preferably 8-72 h, and more preferably 12-24 h; and the curing temperature is preferably room temperature.

In the present invention, after curing, the cured body obtained from the curing is demolded to obtain the primary blank of the artificial mineral board. The present invention has no special requirement on the implementation of demolding, and a manner well known to those skilled in the art can be used.

In the present invention, after the primary blank of the artificial mineral board is obtained, curing and sanding are sequentially conducted on the primary blank of the artificial mineral board to obtain the artificial mineral board. In the present invention, the curing manner is preferably placing under room temperature conditions, and the placing time is preferably 6-14 days, and further preferably 7-10 days. In the present invention, after the curing, sanding is conducted on the cured material to ensure that the surface of the board material is flat and uniform in thickness, and thus a more regular artificial mineral board is obtained. The present invention has no special requirement on the implementation of sanding, and a manner well known to those skilled in the art can be used.

In order to further illustrate the present invention, the weather-resistant composite floor and the preparation method thereof, and the artificially modified mineral board and the preparation method thereof provided by the present invention are described in detail below in connection with the accompanying drawings and embodiments, but they should not be understood as limiting the claimed scope of the present invention.

### Preferred Embodiment 1

3 parts of the modifier (See Table 2 for the specific dosage of the component), 20 parts of the wood chips, 60 parts of the mineral base material, and 20 parts of water were mixed to obtain a slurry, where the mineral base material contained 30 parts of magnesium oxide, 1 part Magnesium Sulfate, and 15 parts of magnesium chloride; the slurry was layered in a mold with a layering thickness of 4 mm, subsequently one layer of fiberglass mesh was layered, and then one layer of the slurry was layered with layering thickness of 3 mm, after layering the layers were allowed to stand, and demolded to obtain the primary blank of the artificial mineral board; and then the primary blank was allowed to stand, and polished, to obtain the artificial mineral board as shown in FIG. 2; and the dimension of the artificial mineral board is 2,400 mm×3,354 mm×5.00 mm;

A polyurethane adhesive was applied to the upper and lower surfaces of the artificial mineral board respectively, such that the wear-resistant paper and the balance paper were pasted to the upper surface and the lower surface of the artificial mineral board respectively (note: the upper surface and the lower surface were only used for differentiating different surfaces, and had no other special meaning), and then maintained at a pressure of 3 MPa at 140° C. for 0.5-30 min, to obtain the semi-finished product of the weather-resistant composite floor;

then, the back lay was pasted to one side of the balance paper of the semi-finished product of the weather-resistant composite floor, and maintained at a pressure of 10 MPa at 20° C. for 70 min, to obtain the weather-resistant composite floor as shown in FIG. 1. The weather-resistant composite floor had the dimension of 255.22 mm×161.93 mm×6.51 mm.

The groove and the flange described in FIG. 3 were respectively processed onto two opposite side end portions of the weather-resistant composite floor, where the height of the flange was consistent with the depth of the groove, and accounted for ⅙ of the thickness of the weather-resistant composite floor.

### Preferred Embodiment 2

The weather-resistant composite floor was prepared according to the method of Embodiment 1, except that the proportions of respective components and the preparation processes were different, and the dosages of respective components and the process parameters were listed in Tables 1-3.

### Preferred Embodiment 3

The weather-resistant composite floor was prepared according to the method of Embodiment 1, except that the proportions of respective components and the preparation processes were different, and the dosages of respective components and the process parameters were listed in Tables 1-3.

### Preferred Embodiment 4

The weather-resistant composite floor was prepared according to the method of Embodiment 1, except that the proportions of respective components and the preparation processes were different, and the dosages of respective components and the process parameters were listed in Tables 1-3.

TABLE 1
Dosages by mass (parts by mass) of artificial mineral boards in Embodiments 1-4

| | | Wood | Magnesium | Magnesium | Magnesium | Artificial | |
|---|---|---|---|---|---|---|---|
| Embodiment | Modifier | Chips | Oxide | Chloride | Sulfate | Perlite | Water |
| 1 | 3 | 20 | 30 | 15 | 1 | 0 | 20 |
| 2 | 5 | 21 | 40 | 25 | 0 | 0 | 22 |
| 3 | 3.5 | 22 | 35 | 28 | 0.5 | 5 | 23 |
| 4 | 4 | 24 | 37 | 25 | 1 | 2 | 25 |

TABLE 2
Dosages (parts by mass) of modifiers in Embodiments 1-4

| | Embodiment | Embodiment | Embodiment | Embodiment |
|---|---|---|---|---|
| Components | 1 | 2 | 3 | 4 |
| Sodium | 2 | 2.5 | 2.4 | 2.1 |
| Methine | | | | |
| Dinaphthyl | | | | |
| Sulphonate | | | | |
| Ferrous Sulfate | 10 | 9 | 12 | 11 |
| Oxalic Acid | 13 | 12 | 15 | 14 |
| Trisodium | 0.6 | 0.5 | 0.8 | 0.7 |
| Phosphate | | | | |
| Sodium Methyl | 0.8 | 0.5 | 1.0 | 0.9 |
| Nitrate | | | | |
| Dibutyl | 0.4 | 0.5 | 0.3 | 0.4 |
| Phthalate | | | | |
| Phenol | 0.8 | 0.7 | 1.0 | 0.9 |
| Xylene | 0.8 | 0.6 | 0.7 | 1.0 |
| Toluene | 0.8 | 0.7 | 0.8 | 1.0 |
| Ethylene- | 0.5 | 0.7 | 0.6 | 0.5 |
| diamine | | | | |
| Sulfuric Acid | 7.0 | 5.0 | 8.0 | 6.5 |
| Sodium | 1.08 | 1.10 | 1.15 | 1.20 |
| Hexameta- | | | | |
| phosphate | | | | |
| Sodium Nitrite | 0.5 | 0.6 | 0.7 | 0.5 |
| Methyl- | 2.0 | 1.8 | 2.2 | 2.5 |
| cellulose | | | | |
| Formaldehyde | 1.0 | 0.8 | 1.2 | 1.4 |
| Casein | 1.0 | 1.2 | 0.8 | 1.5 |
| Gelatin | 8.0 | 7.0 | 7.5 | 7.8 |
| Sodium | 0.02 | 0.03 | 0.05 | 0.04 |
| Pentachloro- | | | | |
| phenolate | | | | |
| Sodium | 0.2 | 0.1 | 0.45 | 0.30 |
| Fluoro- | | | | |
| silicate | | | | |
| Water Glass | 0.6 | 0.7 | 0.8 | 1.0 |
| Water | Balance | Balance | Balance | Balance |

TABLE 3
Parameters of processes for preparing weather-resistant
composite floor in Embodiments 1-4

| | | Embodi- | Embodi- | Embodi- | Embodi- |
|---|---|---|---|---|---|
| Process Parameters | | ment 1 | ment 2 | ment 3 | ment 4 |
| Hot | Temperature/ | 140 | 155 | 185 | 120 |
| Pressing | ° C. | | | | |
| | Pressure/MPa | 3 | 6 | 11 | 13 |
| | Time/min | 30 | 25 | 12 | 30 |
| Cold | Temperature/ | 20 | 25 | 28 | 18 |
| Pressing | ° C. | | | | |
| | Pressure/MPa | 10 | 12 | 10 | 14 |
| | Time/min | 70 | 80 | 90 | 100 |

According to the GB/T 30435-2013 standard, the artificial mineral board and the weather-resistant composite floor obtained in Embodiments 1-4 were tested for thermal expansion and contraction performance, heating shrinkage and warpage performance, and water-soaking shrinkage and warpage performance; where the thermal expansion and contraction performance was obtained by placing the sample at conditions of 0° C., 25° C. and 40° C. each for 24 h and then measuring the length of the sample to calculate the length changing rate; the heating shrinkage and warpage performance was obtained by placing the sample in an oven at 80° C. for 6 h, naturally cooling the sample for 6 h, and testing the changing rates of the length and warping degree of the sample with a test instrument of BA-TA1000L type constant temperature and humidity tester; and the water-soaking shrinkage and warpage performance was obtained by soaking the sample in a water tank full of water for 24 h, wipe-drying the sample and then testing the changing rates of the length and warping degree of the sample. The test results are shown in Table 4.

TABLE 4
Results of performance tests of the artificial mineral boards in Embodiments 1-4

| Test Items | | Embodiment 1 | Embodiment 2 | Embodiment 3 | Embodiment 4 |
|---|---|---|---|---|---|
| Length changing rate | 0-25° C. | −0.0410 | −0.0496 | −0.0454 | −0.0470 |
| caused by thermal | 25-40° C. | −0.0201 | −0.0293 | −0.0214 | −0.0242 |
| expansion and | 0-40° C. | −0.0611 | −0.0789 | −0.0658 | −0.0712 |
| contraction/% | | | | | |
| High-Temperature | Length/% | 0.02 | 0.10 | 0.05 | 0.08 |
| Resistance | Warping | 0.20 | 0.42 | 0.31 | 0.27 |
| Test/80° C. | Degree/mm | | | | |
| Water Soaking Test | Length/% | −0.03 | −0.05 | −0.04 | −0.03 |
| | Thickness/% | −1.42 | −1.22 | −1.30 | −1.34 |
| | Warping | 0.21 | 0.40 | 0.29 | 0.35 |
| | Degree/mm | | | | |

It can be seen from the test results in Table 4 that, after the thermal expansion and contraction test in the range of 0−40° C., the length changing rate of the artificial mineral board provided by the present invention is small, indicating that the artificial mineral board has good dimensional stability in the temperature range of 0−40° C. and can be used in areas with different ambient temperatures.

After the high-temperature resistance test and the water soaking test, the changing rates of both the length and the warping degree of the artificial mineral board are not large, indicating that the artificial mineral board provided by the present invention has excellent high-temperature resistance and waterproof performances.

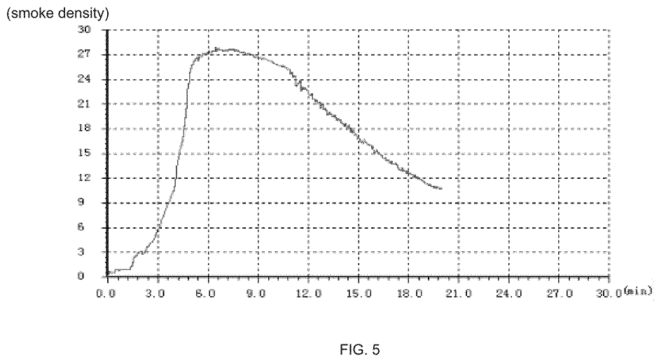

According to the GB/T 30435-2013 standard, the weather-resistant composite floors with the dimension of 250 mm×160 mm×6 mm obtained in Embodiments 1-4 were tested for the heating shrinkage and warpage performance and the water-soaking shrinkage and warpage performance under the same test conditions as those of the artificial mineral board; and the test results for the static bending strength, the wear resistance performance, the residual indentation, the static load and the flame retardant performance of the weather-resistant composite floors are shown in Table 5 and FIG. 5.

FIG. 5 is a relationship diagram between the smoke density of the weather-resistant composite floor obtained in Embodiment 1 and time. It can be seen from the figure that, the smoke density of the weather-resistant composite floor of this Embodiment is maximum at 7-8 min, but of only 27.89, which is significantly reduced as compared with the smoke density of an ordinary floor (an ordinary floor has a smoke density of less than 450). The other Embodiments are tested in the same manner, and the test results are similar to that of Embodiment 1, indicating that the weather-resistant composite floor provided by the present invention has an excellent flame retardant performance.

TABLE 5
Results of performance tests of weather-resistant composite floors in Embodiments 1-4

| Test Items | | Embodiment 1 | Embodiment 2 | Embodiment 3 | Embodiment 4 |
|---|---|---|---|---|---|
| High-Temperature | Length/% | 0.08 | 0.04 | 0.02 | 0.10 |
| Resistance | Warping | 0.0285 | 0.361 | 0.0225 | 0.413 |
| Test | Degree/mm | | | | |
| Water Soaking | Length/% | −0.04 | −0.03 | −0.02 | −0.05 |
| Test | Thickness/% | −1.46 | −1.40 | −1.33 | −1.57 |
| | Warping | 0.284 | 0.373 | 0.2625 | 0.425 |
| | Degree/mm | | | | |

| | | | | |
|---|---|---|---|---|
| Static Bending Intensity/MPa | 17.1 | 16.9 | 16.6 | 16.8 |
| Wear Resistance/Number of | 4820 | 5000 | 4900 | 4870 |
| Revolutions | | | | |
| Residual Indentation/mm | 0.03 | 0.01 | 0.01 | 0.02 |
| Static Load/(mm) | 0.03 | 0.02 | 0.03 | 0.04 |
| Smoke Density | 27.89 | 25.07 | 26.61 | 26.45 |

It can be seen from the test results of Table 5 that, the weather-resistant composite floor provided by the present invention not only has excellent high-temperature resistance and waterproof performances, but also has good strength and wear-resistance performances, and the weather-resistant composite floor has a good capacity of recovering after being subjected to a force, as well as flame retardancy, which meets the requirements of modern building decoration on the dimension, mechanics and flame retardant performance of the floor.

It can be seen from the aforementioned embodiments that, the weather-resistant composite floor provided by the present invention can maintain excellent dimensional stability in the presence of high temperature and moisture, which improves the adaptability of the weather-resistant composite floor to the environment, such that the weather-resistant composite floor has relatively better weather resistance, further expanding the usable range of the weather-resistant composite floor.

Additionally, the weather-resistant composite floor provided by the present invention has relatively small relative density, which is beneficial for transportation and installation of the weather-resistant composite floor; the weather-resistant composite floor provided by the present invention has the flange and the groove for ease of installation, which greatly improves the flooring efficiency and the durability of the connection between the weather-resistant composite floors; and the weather-resistant composite floor provided by the present invention has an easy preparation method, is convenient, and is easy to promote on a large scale.

Although the aforementioned embodiments illustrate the present invention in detail, they are only parts of the embodiments of the present invention, rather than all of the embodiments. Other embodiments can be obtained by people according to these embodiments without the premise of inventiveness, and all of the embodiments fall within the claimed scope of the present invention.

### PARTS LIST

A artificial mineral board
B wear layer
C back lay
1 modified mineral layer
2 fiberglass mesh layer
1-1 modified mineral layer
1-2 modified mineral layer
a flange
b groove

### Listing of Abbreviations

° C. degrees Celsius
g gram
GPa gigapascal
h hour
min minute
mm millimeter
MPa megapascal
μm micrometer

What is claimed is:

1. A weather-resistant composite floor, sequentially comprising a wear layer, an artificial mineral board and a back lay which are laminated and bonded with one another;
wherein the artificial mineral board comprises modified mineral layers and fiberglass mesh layers which are alternately laminated; and the bottom and top layers of the artificial mineral board are the modified mineral layers.

2. The weather-resistant composite floor of claim 1, wherein the raw material forming the modified mineral layers comprises the following components by mass: 60-80 parts of a mineral base material, 20-24 parts of wood chips, 3-5 parts of a modifier, and 20-25 parts of water; and the mineral base material comprises magnesium oxide and magnesium chloride.

3. The weather-resistant composite floor of claim 2, wherein the modifier comprises sodium methine dinaphthyl sulphonate, ferrous sulfate, oxalic acid, trisodium phosphate, sodium methyl nitrate, dibutyl phthalate, phenol, xylene, toluene, ethylenediamine, sulfuric acid, sodium hexametaphosphate, sodium nitrite, methylcellulose, formaldehyde, casein, gelatin, sodium pentachlorophenolate, sodium fluorosilicate, water glass, and water.

4. The weather-resistant composite floor of claim 2, wherein the wood chips comprise straw chips.

5. The weather-resistant composite floor of claim 1, wherein the weather-resistant composite floor has a thickness of 2-12 mm.

6. The weather-resistant composite floor of claim 1, wherein two opposite side end portions of the weather-resistant composite floor are respectively provided with a flange and a groove which can be snap-fitted with the flange.

7. A method for preparing the weather-resistant composite floor of claim 1, comprising the steps of:
(a) pasting a wear-resistant paper onto a top layer of an artificial mineral board, pasting a balance paper onto a bottom layer of the artificial mineral board, and hot pressing to obtain a semi-finished product of the weather-resistant composite floor; and
(b) pasting a back lay onto a face of the balance paper of the semi-finished product of the weather-resistant composite floor obtained in step (a), and then cold pressing to obtain the weather-resistant composite floor.

8. A method for preparing the weather-resistant composite floor of claim 2, comprising the steps of:
(a) pasting a wear-resistant paper onto a top layer of an artificial mineral board, pasting a balance paper onto a bottom layer of the artificial mineral board, and hot pressing to obtain a semi-finished product of the weather-resistant composite floor; and
(b) pasting a back lay onto a face of the balance paper of the semi-finished product of the weather-resistant composite floor obtained in step (a), and then cold pressing to obtain the weather-resistant composite floor.

9. A method for preparing the weather-resistant composite floor of claim 3, comprising the steps of:
(a) pasting a wear-resistant paper onto a top layer of an artificial mineral board, pasting a balance paper onto a bottom layer of the artificial mineral board, and hot pressing to obtain a semi-finished product of the weather-resistant composite floor; and
(b) pasting a back lay onto a face of the balance paper of the semi-finished product of the weather-resistant composite floor obtained in step (a), and then cold pressing to obtain the weather-resistant composite floor.

10. A method for preparing the weather-resistant composite floor of claim 4, comprising the steps of:
(a) pasting a wear-resistant paper onto a top layer of an artificial mineral board, pasting a balance paper onto a bottom layer of the artificial mineral board, and hot pressing to obtain a semi-finished product of the weather-resistant composite floor; and
(b) pasting a back lay onto a face of the balance paper of the semi-finished product of the weather-resistant composite floor obtained in step (a), and then cold pressing to obtain the weather-resistant composite floor.

11. A method for preparing the weather-resistant composite floor of claim 5, comprising the steps of:
(a) pasting a wear-resistant paper onto a top layer of an artificial mineral board, pasting a balance paper onto a bottom layer of the artificial mineral board, and hot pressing to obtain a semi-finished product of the weather-resistant composite floor; and
(b) pasting a back lay onto a face of the balance paper of the semi-finished product of the weather-resistant composite floor obtained in step (a), and then cold pressing to obtain the weather-resistant composite floor.

12. A method for preparing the weather-resistant composite floor of claim 6, comprising the steps of:
(a) pasting a wear-resistant paper onto a top layer of an artificial mineral board, pasting a balance paper onto a bottom layer of the artificial mineral board, and hot pressing to obtain a semi-finished product of the weather-resistant composite floor; and
(b) pasting a back lay onto a face of the balance paper of the semi-finished product of the weather-resistant composite floor obtained in step (a), and then cold pressing to obtain the weather-resistant composite floor.

13. The preparation method of claim 7, wherein in step (a) the heat-pressing temperature is 100-190° C.; the heat-pressing pressure is 2-15 MPa; and the heat-pressing time is 0.5-30 min.

14. The weather-resistant composite floor of claim 1, wherein the artificial mineral board comprises the modified mineral layers and the fiberglass mesh layers which are alternately laminated; and the bottom and top layers of the artificial mineral board are the modified mineral layers.

15. The weather-resistant composite floor of claim 2, wherein the artificial mineral board comprises the modified mineral layers and the fiberglass mesh layers which are alternately laminated; and the bottom and top layers of the artificial mineral board are the modified mineral layers.

16. The artificial mineral board in the weather-resistant composite floor prepared by the preparation method of claim 7, wherein the artificial mineral board comprises the modified mineral layers and the fiberglass mesh layers which are alternately laminated; and the bottom and top layers of the artificial mineral board are the modified mineral layers.

17. The artificial mineral board in the weather-resistant composite floor prepared by the preparation method of claim 13, wherein the artificial mineral board comprises the modified mineral layers and the fiberglass mesh layers which are alternately laminated; and the bottom and top layers of the artificial mineral board are the modified mineral layers.

18. A method for preparing the artificial mineral board of claim 14, comprising the steps of:
(1) mixing raw materials of the modified mineral layer to undergo a modification reaction, so as to obtain a modified mineral slurry;
(2) alternately laying the modified mineral slurry obtained in step (1) and the fiberglass mesh into a mold, and then sequentially curing and demolding to obtain a primary blank of the artificial mineral board containing the modified mineral layers and the fiberglass mesh layers which are set as alternately laminated; wherein the bottom and top layers of the primary blank of the artificial mineral board are the modified mineral layers; and
(3) sequentially performing curing and sanding on the primary blank of the artificial mineral board obtained in step (2) to obtain the artificial mineral board.

19. A method for preparing the artificial mineral board of claim 15, comprising the steps of:
(1) mixing raw materials of the modified mineral layer to undergo a modification reaction, so as to obtain a modified mineral slurry;
(2) alternately laying the modified mineral slurry obtained in step (1) and the fiberglass mesh into a mold, and then sequentially curing and demolding to obtain a primary blank of the artificial mineral board containing the modified mineral layers and the fiberglass mesh layers which are set as alternately laminated; wherein the bottom and top layers of the primary blank of the artificial mineral board are the modified mineral layers; and
(3) sequentially performing curing and sanding on the primary blank of the artificial mineral board obtained in step (2) to obtain the artificial mineral board.

20. A method for preparing the artificial mineral board of claim 17, comprising the steps of:
(1) mixing raw materials of the modified mineral layer to undergo a modification reaction, so as to obtain a modified mineral slurry;
(2) alternately laying the modified mineral slurry obtained in step (1) and the fiberglass mesh into a mold, and then sequentially curing and demolding to obtain a primary blank of the artificial mineral board containing the modified mineral layers and the fiberglass mesh layers which are set as alternately laminated; wherein the bottom and top layers of the primary blank of the artificial mineral board are the modified mineral layers; and
(3) sequentially performing curing and sanding on the primary blank of the artificial mineral board obtained in step (2) to obtain the artificial mineral board.

21. The weather-resistant composite floor of claim 2, wherein the mineral base material also comprises magnesium sulfate.
